(19) United States
(12) Patent Application Publication
(10) Pub. No.: US 2012/0276412 A1
(43) Pub. Date: Nov. 1, 2012

(54) Surface-Treated Copper Foil

(75) Inventor: Atsushi Miki, Ibaraki (JP)

(73) Assignee: JX Nippon Mining & Metals Corporation, Tokyo (JP)

(21) Appl. No.: 13/518,051

(22) PCT Filed: Dec. 17, 2010
(86) PCT No.: PCT/JP2010/072755

§ 371 Date: Jul. 10, 2012

(30) Foreign Application Priority Data
Dec. 24, 2009 (JP) 2009-292684

(51) Int. Cl. B32B 15/04; C25D 7/06; B32B 15/20

(52) U.S. Cl. 428/671; 205/152

(57) ABSTRACT

Provided is a surface-treated copper foil, wherein a plated layer essentially consisting of cobalt and nickel, in which a total amount of cobalt and nickel is 75 μg/dm² or more and 200 μg/dm² or less and Co/Ni is 1 or more and 3 or less, is provided on the roughened surface of a copper foil. The present invention aims to form a surface-treated copper foil, which has superior alkali etching properties and maintains favorable characteristics of hydrochloric acid resistance, heat resistance and weather resistance, and of which the surface takes on a red color.

### TECHNICAL FIELD

The present invention relates to a surface-treated copper foil, and in particular relates to a surface-treated copper foil in which, by forming a plated layer essentially consisting of cobalt and nickel and a chromium-zinc rustproof layer after performing copper roughening treatment, superior alkali etching properties are yielded, favorable characteristics of hydrochloric acid resistance, heat resistance, and weather resistance are maintained, and the surface of the surface-treated copper foil is of a red color. More specifically, the present invention relates to a surface-treated copper foil which is suitable for use in a flexible substrate capable of forming a fine pattern circuit, as well as to the treating method thereof.

### BACKGROUND ART

Generally speaking, a copper foil for flexible substrate is used to form various types of flexible substrates for use in electronic devices via a process in which a flexible resin base material such as polyimide resin is applied on the copper foil and dried to solidification or a copper foil is adhesively-laminated onto a flexible resin base material including an adhesive layer or the like under high temperature and high pressure, a circuit is printed, an intended circuit is thereafter obtained by removing the unwanted portions via etching treatment, and given elements are finally soldered thereon.

A copper foil for use in a flexible substrate is normally required to be provided with a surface (roughened surface) to be bonded with the resin base material, and a non-bonding surface (glossy surface). The roughened surface is demanded of the following; namely, there is no oxidative discoloration during storage, the peeling strength from the base material is sufficient even after high-temperature heating, wet processing, soldering, chemical treatment and the like, there is no layer contamination that arises on.

Meanwhile, the glossy surface is demanded of the following; namely, the external appearance is favorable under normal circumstances, there is no oxidative discoloration during storage, the solder wettability is favorable, there is no oxidative discoloration during high-temperature heating, adhesiveness with the resist is favorable, and so on.

In order to meet the foregoing demands, numerous treating methods of a copper foil for use in a flexible substrate have been proposed. Generally speaking, the treating method will differ between a rolled copper foil and an electrolytic copper foil, but fundamentally, there is a method of performing roughening treatment to a degreased copper foil, performing rustproof treatment as needed, and additionally performing silane treatment and annealing as needed.

Generally speaking, roughening treatment needs to be performed to a copper foil, and in particular this is a process step that is required for improving the adhesiveness with resin. As the roughening treatment, a copper roughening treatment of subjecting copper to electrodeposition was initially adopted, but numerous techniques have been proposed for improving the surface condition of the copper foil along with the advancement of electronic circuits. In particular, the copper-nickel roughening treatment which aims to improve the thermal peeling strength, hydrochloric acid resistance and oxidation resistance is an effective means (refer to Patent Document 1).

The copper-nickel-treated surface takes on a black color, and, particularly with a rolled foil for use in a flexible substrate, the black color resulting from the copper-nickel treatment is acknowledged to typify this type of product. The copper-nickel roughening treatment is superior in terms of thermal peeling strength, oxidation resistance and hydrochloric acid resistance; but etching with an alkali etching solution, which is now important for use in the treatment of fine patterns, is difficult to be performed, and there is a problem in that unetched residues remain on the treated layer during the formation of fine patterns having 150 μm pitch or less.

Thus, for the treatment of fine patterns, the present applicant previously developed Cu—Co treatment (refer to Patent Document 2 and Patent Document 3) and Cu—Co—Ni treatment (refer to Patent Document 4). Nevertheless, while these roughening treatments were favorable with respect to the etching properties, alkali etching properties and hydrochloric acid resistance, it was once again discovered that the thermal peeling strength deteriorates when an acrylic adhesive is used, and the color was also brown to dark brown, and did not reach the level of black.

Pursuant to the trend of finer patterns and diversification of printed circuits in recent years, there are further demands for possessing thermal peeling strength (especially upon using an acrylic adhesive) and hydrochloric acid resistance that are comparable to the case of performing Cu—Ni treatment, enabling the etching of printed circuits having a pattern of 150 μm pitch or less using an alkali etching solution, and enabling the improvement of weather resistance.

In other words, when the circuit becomes finer, the circuit tends to more easily peel off due to the hydrochloric acid etching solution, and it is necessary to prevent such peeling. When the circuit becomes finer, the circuit also tends to more easily peel off due to the high temperature during soldering and other processes, and it is also necessary to prevent such peeling.

Today, with the development of even finer patterns, for instance, the enablement of etching of printed circuits having a pattern of 150 μm pitch or less using a CuCl₂ etching solution is essential, and alkali etching is also becoming essential pursuant to the diversification of the resist and the like.

An object of this invention is to develop a method of treating a copper foil, which comprises the numerous generalized properties described above as a copper foil for use in a flexible substrate, as well as the various characteristics described above which are comparable to Cu—Ni treatment, and of which the thermal peeling strength will not deteriorate even when an acrylic adhesive is used, and the weather resistance and alkali etching properties are superior.

In light of the above, the present applicant provided a method of treating a copper foil for use in a flexible substrate, wherein a cobalt plated layer or a plated layer essentially consisting of cobalt and nickel is formed on the copper foil surface after performing copper roughening treatment to the surface of the copper foil, and the surface of copper foil has a blackened color that is comparable to the case of performing Cu—Ni treatment (refer to Patent Document 5).

The surface-treated copper foil obtained with the foregoing treating method is a superior one that is still being used today as a surface-treated copper foil having a black surface color which is suitable for a flexible substrate capable of forming a fine pattern circuit.

Relative to the foregoing surface-treated copper foil having a black surface color, a surface-treated copper foil having a red surface color is generally referred to as a red-treated copper foil, and commonly used as a copper foil for a flexible substrate to be used in vehicles and the like.

While the black surface treatment is superior in terms of the positioning accuracy of the flexible substrate, the red surface treatment is performed to obtain an essential surface color for improving the positioning accuracy and determining the quality in the AOI process based on the color resulting from the copper foil surface treatment which is transmissive from the substrate resin side. In other words, when used for a flexible substrate that uses a copper foil of which surface is red-treated, the black portion is identified as a defective portion in the copper circuit caused by oxidation.

Thus, it is crucially important that the surface-treated copper foil takes on a red color while maintaining the copper foil properties.

However, since the roughened particles from the surface treatment are mainly configured from copper, a red-treated copper foil has a weak rustproof effect and inferior weather resistance in comparison to the foregoing surface treatment that yields a black color, and there were cases where “discoloration streaks” and “discoloration spots” would occur due to surface oxidation.

Conventionally, while such “discoloration streaks” and “discoloration spots” were recognized as not being particularly problematic in terms of the copper foil characteristics, in recent years drawbacks have been indicated in that the “discoloration streaks” and “discoloration spots” are transferred to the resin base material made of polyimide or the like at the stage of forming the flexible substrate to cause “discoloration streaks” and “discoloration spots” thereon after the circuit etching process. Thus, a red-treated copper foil that is free from such “discoloration streaks” and “discoloration spots” is being demanded.

### PRIOR ART DOCUMENTS

[Patent Document 1] Japanese Laid-Open Patent Publication No. S52-145769

[Patent Document 2] Japanese Patent Publication No. S63-2158

[Patent Document 3] Japanese Patent Application No. H1-112227

[Patent Document 4] Japanese Patent Application No. H 1-112226

[Patent Document 5] Japanese Patent Publication No. H6-54829

### SUMMARY OF INVENTION

An object of the present invention is to provide a surface-treated copper foil, which has superior alkali etching properties and maintains favorable characteristics of hydrochloric acid resistance, heat resistance and weather resistance, and of which surface takes on a red color; wherein a cobalt and nickel layer is formed on the surface of a copper foil that was subject to copper roughening treatment, and a rustproof layer is additionally formed thereon as needed.

In order to achieve the foregoing object, as a result of intense study, the present inventors discovered that, by forming a plated layer of cobalt and nickel having an appropriate composition, it is possible to maintain favorable characteristics of hydrochloric acid resistance, heat resistance, and weather resistance, and cause the surface of the surface-treated copper foil to be a red color.

Based on the foregoing discovery, the present invention provides:
1) A surface-treated copper foil, wherein a plated layer essentially consisting of cobalt and nickel, in which a total amount of cobalt and nickel is 75 μg/dm² or more and 200 μg/dm² or less and Co/Ni is 1 or more and 3 or less, is provided on the roughened surface of a copper foil;
2) The surface-treated copper foil according to 1) above, wherein a rustproof layer consisting of a mixed film of chromium oxide and zinc and/or zinc oxide is provided on the plated layer essentially consisting of cobalt and nickel;
3) The surface-treated copper foil according to 2) above, wherein a silane coupling agent is provided on the rustproof layer; and
4) The surface-treated copper foil according to any one of 1) to 3) above; wherein, according to a color difference ΔE* based on JIS Z 8730, when a color difference after performing the copper roughening treatment is expressed in ΔE*(A), a color difference after performing electroplating treatment for yielding a rustproof effect in addition to performing the copper roughening treatment is expressed in ΔE*(B), and ΔE*(A)−ΔE*(B) is expressed in ΔE*(C), ΔE*(C) is 2 or more and 9 or less.

### EFFECT OF INVENTION

The surface-treated copper foil of the present invention, in which a cobalt and nickel layer is formed on the surface of a copper foil that was subject to copper roughening treatment, and a rustproof layer is additionally formed thereon as needed, has superior alkali etching properties, and maintains favorable characteristics of hydrochloric acid resistance, heat resistance and weather resistance; and this copper foil allows for achieving the surface of a red color.

### DESCRIPTION OF EMBODIMENTS

As the copper foil used in the present invention, either an electrolytic copper foil or a rolled copper foil may be used. In order to improve the peeling strength of the copper foil after lamination, the surface of the copper foil to be bonded with the resin base material, namely the roughened surface of the copper foil, is normally subject to copper roughening treatment in which electrodeposition is performed onto the surface of a degreased copper foil to obtain a knobbed copper surface. The foregoing electrodeposition of knobbed copper can be easily realized by performing so-called dendritic electrodeposition.

Normal copper plating or the like may be performed as the pretreatment before the roughening process, and/or as the finishing process after the roughening process. The contents of the treatment may be slightly different between a rolled copper foil and an electrolytic copper foil. In the present invention, publicly known treatments related to copper roughening including, as appropriate, the foregoing pretreatment and finishing processes are collectively referred to as the “copper roughening treatment”.

The following conditions may be adopted as an example of the copper roughening treatment. Moreover, a publicly known copper plating treatment may be concurrently performed in the copper roughening treatment.

Copper roughening treatment

Cu: 10 to 25 g/L

H₂SO₄: 20 to 100 g/L

Temperature: 20 to 40° C.

Dk: 30 to 70 A/dm²

Time: 1 to 5 seconds

In the present invention, copper roughening treatment is performed, and a plated layer essentially consisting of cobalt and nickel is thereafter formed.

The cobalt and nickel plating conditions are as follows:

Cobalt-nickel plating

Co: 1 to 30 g/L

Ni: 1 to 30 g/L

Temperature: 30 to 80° C.

pH: 1.0 to 3.5

Dk: 1.0 to 10.0 A/dm²

Time: 0.5 to 4 seconds

The foregoing cobalt-nickel plating is an important requirement of the present invention. Specifically, based on the foregoing plating conditions, formed is a plated layer essentially consisting of cobalt and nickel in which the total amount of cobalt and nickel is 75 μg/dm² or more and less than 200 μg/dm² and Co/Ni is 1 or more and 3 or less.

As a result of adjusting each amount to be within the foregoing range, it is possible to obtain a surface-treated copper foil, which has superior alkali etching properties and maintains favorable characteristics of hydrochloric acid resistance, heat resistance and weather resistance, and of which the surface takes on a red color.

Thereafter, rustproof treatment is performed as needed. The preferred rustproof treatment in the present invention is coating treatment with the mixture of chromium oxide and zinc/zinc oxide. This coating treatment with the mixture of chromium oxide and zinc/zinc oxide is a treatment to form a rustproof layer of a zinc-chromate-based mixture made of zinc or zinc oxide and chromium oxide by way of electroplating using a plating bath containing zinc salt or zinc oxide and chromate.

As the plating bath, representatively used is a mixed aqueous solution of at least one from bichromate such as K₂Cr₂O₇ and Na₂Cr₂O₇, or CrO₃; at least one from soluble zinc salt such as ZnO and ZnSO₄.7H₂O; and alkali hydroxide or sulfuric acid.

The representative plating bath composition and electrolysis conditions are as follows:

K₂Cr₂O₇ (Na₂Cr₂O₇, CrO₃): 2 to 10 g/L

NaOH or KOH or H₂SO₄: 10 to 50 g/L

ZnO or ZnSO₄.7H₂O: 0.05 to 10 g/L

pH: 2 to 13

Bath Temperature: 20 to 80° C.

Current Density: 0.05 to 5 A/dm²

Time: 2 to 30 seconds

Anode: Pt—Ti plate, stainless steel plate, etc.

Generally speaking, the plating amount of chromium oxide is within a range that the plating amount of chromium is 15 μg/dm² or more, and the plating amount of zinc is 30 μg/dm² or more. The thickness may differ between the roughened surface side and the glossy surface side. As the rustproof method, the methods described in Japanese Patent Publication No. S58-7077, Japanese Patent Publication No. S61-33908, and Japanese Patent Publication No. S62-14040 may be used.

The copper foil obtained as a result of the above has thermal peeling strength, oxidation resistance and hydrochloric acid resistance that are comparable to the case of performing Cu—Ni treatment, enables etching the printed circuits having a pattern of 150 μm pitch or less with a CuCl₂ etching solution, and additionally has superior alkali etching properties. As the alkali etching solution, for instance, a solution (temperature 50° C.) consisting of NH₄OH solution with 6 mol/L, NH₄Cl solution with 5 mol/L, and CuCl₂ solution with 2 mol/L is known.

As needed, a silane treatment of applying a silane coupling agent on the plated layer essentially consisting of cobalt and nickel or on the rustproof layer formed thereon may be performed in order to improve the adhesion between the copper foil and the resin substrate.

The application method of the silane coupling agent may be any of the like.

### EXAMPLES

The present invention is now explained based on the Examples and Comparative Examples. Note that these Examples are merely illustrative, and the present invention shall in no way be limited thereby. In other words, various modifications and other embodiments based on the technical spirit claimed in the claims shall be included in the present invention as a matter of course.

### Example 1

Copper roughening treatment was performed to a rolled copper foil under the foregoing (normal) conditions for causing copper to be adhered in an amount of 20 mg/dm², and water washing was thereafter performed. Based on the foregoing cobalt-nickel plating conditions, the cobalt plating amount was 111 μg/dm² and the nickel plating amount was 70 μg/dm². After further water washing, rustproof treatment was performed, and a silane coupling agent was subsequently applied and dried to produce a cobalt-nickel-plated copper foil.

The total of the cobalt plating amount and the nickel plating amount was 181 μg/dm², and Co/Ni was 1.59. This surface-treated copper foil satisfied the conditions of the present invention; namely, the total amount of cobalt and nickel is 75 μg/dm² or more and 200 μg/dm² or less, and Co/Ni is 1 or more and 3 or less.

Using this surface-treated copper foil, the color difference ΔE* based on JIS Z 8730 was examined. The MiniScan XE Plus colorimeter manufactured by HunterLab was used to measure the color difference. After the calibration work before the measurement using this colorimeter, the color difference ΔE*(A) of the copper foil to which only the copper roughening treatment was performed was measured, and the color difference ΔE*(B) of the foregoing cobalt-nickel-plated copper foil was thereafter measured so as to calculate ΔE*(C) based on ΔE*(A)−ΔE*(B)=ΔE*(C).

In addition, this surface-treated copper foil was adhesively-laminated onto a glass cloth base epoxy resin plate. This was subject to measurement of the normal (room temperature) peeling strength (kg/cm). Subsequently, the rate of deterioration in hydrochloric acid resistance was obtained by measuring the peeling strength after dipping the foregoing laminate in an 18% hydrochloric acid solution for 1 hour using a circuit having a width of 0.2 mm, and the rate of deterioration in heat resistance was obtained by measuring the peeling strength after heating at 180° C.×48 hours using a circuit having a width of 10 mm. In order to examine the weather resistance, the scroll-like surface-treated copper foil was placed in an incubator under an atmosphere in which the temperature is 60° C. and the humidity is 60% to implement a weathering test.

In the weathering test, the scroll-like surface-treated copper foil was set for a holding time corresponding to 30 days under the foregoing conditions, and the scroll-like surface-treated copper foil was thereafter wound off. The surface-treated copper foil was evaluated as “◯” (favorable) when no discoloration was observed on the roughened surface, and evaluated as “×” (inferior) when it did not meet the foregoing condition. In order to examine the alkali etching properties, the surface-treated copper foil was dipped for 30 seconds in an alkali etching solution (temperature 50° C.) consisting of NH₄OH solution with 6 mol/L, NH₄Cl solution with 5 mol/L, and CuCl₂ solution with 2 mol/L, and the surface-treated copper foil was evaluated as “◯” (favorable) when there were no residual roughened particles on the copper foil surface, and evaluated as “×” (inferior) when it did not meet the foregoing condition.

The foregoing results are shown in Table 1. As shown in Table 1, according to the color difference measurement based on WS Z 8730 and the calculation result of ΔE*(C), ΔE*(C) was 8, and the copper foil surface took on a uniform red color. Moreover, the generation of black colored “discoloration streaks” after the evaluation of the weather resistance was not observed at all, and the evaluation result was “◯”.

The rate of deterioration in hydrochloric acid resistance was 1.4%, and the rate of deterioration in heat resistance after 48 hours was 14.7%. The copper foil had favorable hydrochloric acid resistance and heat resistance. In addition, residual roughened particles were not observed after dipping in the solution, and the evaluation result with respect to the alkali etching properties was “◯”.

TABLE 1

| | | | | | Rate of deterioration in | Rate of deterioration | | Alkali | Color |
|---|---|---|---|---|---|---|---|---|---|
| | Ni | Co | | | hydrochloric acid resistance | in heat resistance | Weathering | etching | difference |
| | content | content | Co + Ni | Co/Ni | (%) | (%) | test | properties | ΔE*(C) |
| Example 1 | 70 | 111 | 181 | 1.59 | 1.4 | 14.7 | ∘ | ∘ | 8 |
| Example 2 | 37 | 73 | 110 | 1.97 | 3.2 | 19.4 | ∘ | ∘ | 6 |
| Example 3 | 28 | 52 | 80 | 1.86 | 4.9 | 20.0 | ∘ | ∘ | 3 |
| Example 4 | 38 | 38 | 76 | 1.00 | 5.5 | 21.0 | ∘ | ∘ | 3 |
| Example 5 | 50 | 150 | 200 | 3.00 | 2.5 | 15.2 | ∘ | ∘ | 9 |
| Comparative | 0 | 0 | 0 | — | 5.2 | 35.0 | x | ∘ | 1 |
| Example 1 | | | | | | | | | |
| Comparative | 114 | 0 | 114 | 0 | 6.5 | 29.0 | ∘ | x | 6 |
| Example 2 | | | | | | | | | |
| Comparative | 375 | 774 | 1149 | 2.06 | 1.0 | 22.0 | ∘ | x | 12 |
| Example 3 | | | | | | | | | |
| Comparative | 16 | 43 | 59 | 2.69 | 5.5 | 25.0 | x | ∘ | 3 |
| Example 4 | | | | | | | | | |
| Comparative | 35 | 130 | 165 | 3.71 | 1.3 | 29.5 | ∘ | ∘ | 7 |
| Example 5 | | | | | | | | | |
| Comparative | 60 | 42 | 102 | 0.70 | 5.5 | 25.0 | ∘ | ∘ | 4 |
| Example 6 | | | | | | | | | |

### Example 2

Copper roughening treatment was performed to a rolled copper foil under the foregoing (normal) conditions for causing copper to be adhered in an amount of 20 mg/dm², and water washing was thereafter performed. The two-stage plating was performed based on the foregoing cobalt-nickel plating conditions, and resulted in the cobalt plating amount being 73 μg/dm² and the nickel plating amount being 37 μg/dm². After further water washing, rustproof treatment was performed, and a silane coupling agent was subsequently applied and dried to produce a cobalt-nickel-plated copper foil.

The total of the cobalt plating amount and the nickel plating amount was 110 μg/dm², and Co/Ni was 1.97. This surface-treated copper foil satisfied the conditions of the present invention; namely, the total amount of cobalt and nickel is 75 μg/dm² or more and 200 μg/dm² or less, and Co/Ni is 1 or more and 3 or less.

Under the same conditions as Example 1, the color difference ΔE*(C) was examined, and also the rate of deterioration in hydrochloric acid resistance, the rate of deterioration in heat resistance after 48 hours, the weathering test, and the alkali etching properties were examined. The foregoing results are shown in Table 1.

The color difference ΔE*(C) was 6, and the copper foil surface took on a uniform red color. The weathering test results were also “◯”.

The rate of deterioration in hydrochloric acid resistance was 3.2%, and the rate of deterioration in heat resistance after 48 hours was 19.4%. The copper foil had favorable hydrochloric acid resistance and heat resistance. In addition, residual roughened particles were not observed after dipping in the solution, and the evaluation result with respect to the alkali etching properties was “◯”.

### Example 3

Copper roughening treatment was performed to a rolled copper foil under the foregoing (normal) conditions for causing copper to be adhered in an amount of 20 mg/dm², and water washing was thereafter performed. The two-stage plating was performed based on the foregoing cobalt-nickel plating conditions, and resulted in the cobalt plating amount being 52 μg/dm² and the nickel plating amount being 28 μg/dm². After further water washing, rustproof treatment was performed, and a silane coupling agent was subsequently applied and dried to produce a cobalt-nickel-plated copper foil.

The total of the cobalt plating amount and the nickel plating amount was 80 μg/dm², and Co/Ni was 1.86. This surface-treated copper foil satisfied the conditions of the present invention; namely, the total amount of cobalt and nickel is 75 μg/dm² or more and 200 μg/dm² or less, and Co/Ni is 1 or more and 3 or less.

Under the same conditions as Example 1, the color difference ΔE*(C) was examined, and also the rate of deterioration in hydrochloric acid resistance, the rate of deterioration in heat resistance after 48 hours, the weathering test, and the alkali etching properties were examined.

The foregoing results are shown in Table 1.

The color difference ΔE*(C) was 3, and the copper foil surface took on a uniform red color. The weathering test results were also “◯”.

The rate of deterioration in hydrochloric acid resistance was 4.9%, and the rate of deterioration in heat resistance after 48 hours was 20.0%. The copper foil had favorable hydrochloric acid resistance and heat resistance. In addition, residual roughened particles were not observed after dipping in the solution, and the evaluation result with respect to the alkali etching properties was “◯”.

### Example 4

Copper roughening treatment was performed to a rolled copper foil under the foregoing (normal) conditions for causing copper to be adhered in an amount of 20 mg/dm², and water washing was thereafter performed. The two-stage plating was performed based on the foregoing cobalt-nickel plating conditions, and resulted in the cobalt plating amount being 38 μg/dm² and the nickel plating amount being 38 μg/dm². After further water washing, rustproof treatment was performed, and a silane coupling agent was subsequently applied and dried to produce a cobalt-nickel-plated copper foil.

The total of the cobalt plating amount and the nickel plating amount was 76 μg/dm², and Co/Ni was 1.00. This surface-treated copper foil satisfied the conditions of the present invention; namely, the total amount of cobalt and nickel is 75 μg/dm² or more and 200 μg/dm² or less, and Co/Ni is 1 or more and 3 or less.

Under the same conditions as Example 1, the color difference ΔE*(C) was examined, and also the rate of deterioration in hydrochloric acid resistance, the rate of deterioration in heat resistance after 48 hours, the weathering test, and the alkali etching properties were examined. The foregoing results are shown in Table 1.

The color difference ΔE*(C) was 3, and the copper foil surface took on a uniform red color. The weathering test results were also “◯”.

The rate of deterioration in hydrochloric acid resistance was 5.5%, and the rate of deterioration in heat resistance after 48 hours was 21.0%. The copper foil had favorable hydrochloric acid resistance and heat resistance. In addition, residual roughened particles were not observed after dipping in the solution, and the evaluation result with respect to the alkali etching properties was “◯”.

### Example 5

Copper roughening treatment was performed to a rolled copper foil under the foregoing (normal) conditions for causing copper to be adhered in an amount of 20 mg/dm², and water washing was thereafter performed. The two-stage plating was performed based on the foregoing cobalt-nickel plating conditions, and resulted in the cobalt plating amount being 150 μg/dm² and the nickel plating amount being 50 μg/dm². After further water washing, rustproof treatment was performed, and a silane coupling agent was subsequently applied and dried to produce a cobalt-nickel-plated copper foil.

The total of the cobalt plating amount and the nickel plating amount was 200 μg/dm², and Co/Ni was 3.00. This surface-treated copper foil satisfied the conditions of the present invention; namely, the total amount of cobalt and nickel is 75 μg/dm² or more and 200 μg/dm² or less, and Co/Ni is 1 or more and 3 or less.

Under the same conditions as Example 1, the color difference ΔE*(C) was examined, and also the rate of deterioration in hydrochloric acid resistance, the rate of deterioration in heat resistance after 48 hours, the weathering test, and the alkali etching properties were examined. The foregoing results are shown in Table 1.

The color difference ΔE*(C) was 9, and the copper foil surface took on a uniform red color. The weathering test results were also “◯”.

The rate of deterioration in hydrochloric acid resistance was 2.5%, and the rate of deterioration in heat resistance after 48 hours was 15.2%. The copper foil had favorable hydrochloric acid resistance and heat resistance. In addition, residual roughened particles were not observed after dipping in the solution, and the evaluation result with respect to the alkali etching properties was “◯”.

### Comparative Example 1

With Comparative Example 1, a rolled copper foil was used as in Example 1, and, as with Example 1, copper roughening treatment was performed for causing copper to be adhered in an amount of 20 mg/dm². Water washing and rustproof treatment were thereafter performed, and a silane coupling agent was subsequently applied and dried to produce a roughened copper foil. Under the same conditions as Example 1, the color difference ΔE*(C) was examined, and also the rate of deterioration in hydrochloric acid resistance, the rate of deterioration in heat resistance after 48 hours, the weathering test, and the alkali etching properties were examined.

The foregoing results are shown in Table 1. The color difference ΔE*(C) was 1, and the copper foil surface took on a red color that was more brilliant than Example 1. The rate of deterioration in hydrochloric acid resistance was favorable at 5.2%, but the rate of deterioration in heat resistance after 48 hours became considerably inferior at 35%. In the weathering test, “discoloration streaks” were observed and the evaluation result was “×”. The alkali etching properties were evaluated as “◯”.

### Comparative Example 2

With Comparative Example 2, a rolled copper foil was used as in Example 1, and, as with Example 1, copper roughening treatment was performed for causing copper to be adhered in an amount of 20 mg/dm², but the Cu plating amount was 10 mg/dm² and the Ni plating amount was 114 μg/dm² according to the range of the following Cu—Ni plating conditions.

The plating conditions were as follows.

Cu: 5 to 10 g/L

Ni: 10 to 20 g/L

pH: 1 to 4

Temperature: 20 to 40° C.

Dk: 10 to 30 A/dm²

Time: 2 to 5 seconds

Under the same conditions as Example 1, the color difference ΔE*(C) was examined, and also the rate of deterioration in hydrochloric acid resistance, the rate of deterioration in heat resistance after 48 hours, the weathering test, and the alkali etching properties were examined.

The foregoing results are shown in Table 1. The color difference ΔE*(C) was “×”, and the copper foil surface took on a black color. While the rate of deterioration in hydrochloric acid resistance was favorable at 6.5%, the rate of deterioration in heat resistance after 48 hours became considerably inferior at 29.0%. The weathering test results were “◯”, but the alkali etching properties were evaluated as “×”.

### Comparative Example 3

With Comparative Example 3, a plated layer of cobalt and nickel was formed as in Example 1, but the total of the cobalt plating amount and the nickel plating amount was 1149 μg/dm², and Co/Ni was 2.06. This surface-treated copper foil did not satisfy the condition of the present invention; namely, the total amount of cobalt and nickel is 75 μg/dm² or more and 200 μg/dm² or less.

Under the same conditions as Example 1, the color difference ΔE*(C) was examined, and also the rate of deterioration in hydrochloric acid resistance, the rate of deterioration in heat resistance after 48 hours, the weathering test, and the alkali etching properties were examined.

The foregoing results are shown in Table 1. The color difference ΔE*(C) was 11, causing the redness decrease, and the copper foil surface took on a dusky red-violet color. While the rate of deterioration in hydrochloric acid resistance was 1.0%, the rate of deterioration in heat resistance after 48 hours was favorable at 22.0%. The weathering test results were “◯”, and the alkali etching properties were evaluated as “◯”.

### Comparative Example 4

With Comparative Example 4, a plated layer of cobalt and nickel was formed as in Example 1, but the total of the cobalt plating amount and the nickel plating amount was 59 μg/dm², and Co/Ni was 2.69. This surface-treated copper foil did not satisfy the condition of the present invention; namely, the total amount of cobalt and nickel is 75 μg/dm² or more and 200 μg/dm² or less.

Under the same conditions as Example 1, the color difference ΔE*(C) was examined, and also the rate of deterioration in hydrochloric acid resistance, the rate of deterioration in heat resistance after 48 hours, the weathering test, and the alkali etching properties were examined.

The foregoing results are shown in Table 1. The color difference ΔE*(C) was 3, and the copper foil surface took on a red color that was more brilliant than Example 1. The rate of deterioration in hydrochloric acid resistance was favorable at 5.5%, but the rate of deterioration in heat resistance after 48 hours became inferior at 25%. In the weathering test, “discoloration streaks” were observed and the evaluation result was “×”. The alkali etching properties were favorable and evaluated as “◯”.

### Comparative Example 5

With Comparative Example 5, a plated layer of cobalt and nickel was formed as in Example 1, but the total of the cobalt plating amount and the nickel plating amount was 165 μg/dm², and Co/Ni was 3.71. This surface-treated copper foil did not satisfy the condition of the present invention; namely, Co/Ni is 1 or more and 3 or less.

Under the same conditions as Example 1, the color difference ΔE*(C) was examined, and also the rate of deterioration in hydrochloric acid resistance, the rate of deterioration in heat resistance after 48 hours, the weathering test, and the alkali etching properties were examined.

The foregoing results are shown in Table 1. The rate of deterioration in hydrochloric acid resistance was favorable at 1.3%, the weathering test results were “◯”, the alkali etching properties were favorable and evaluated as “◯”, and the color difference ΔE*(C) was favorable at 7, but the rate of deterioration in heat resistance after 48 hours became considerably inferior at 29.5%.

### Comparative Example 6

With Comparative Example 6, a plated layer of cobalt and nickel was formed as in Example 1, but the total of the cobalt plating amount and the nickel plating amount was 102 μg/dm², and Co/Ni was 0.70. The surface-treated copper foil did not satisfy the condition of the present invention; namely, Co/Ni is 1 or more and 3 or less.

Under the same conditions as Example 1, the color difference ΔE*(C) was examined, and also the rate of deterioration in hydrochloric acid resistance, the rate of deterioration in heat resistance after 48 hours, the weathering test, and the alkali etching properties were examined.

The foregoing results are shown in Table 1. The color difference ΔE*(C) was 4, and the copper foil surface took on a red color that was more brilliant than Example 1. The rate of deterioration in hydrochloric acid resistance was favorable at 5.5%, but the rate of deterioration in heat resistance after 48 hours became inferior at 25%. The weathering test results were “◯”, and the alkali etching properties were favorable and evaluated as “◯”.

### INDUSTRIAL APPLICABILITY

The surface-treated copper foil of the present invention, in which a cobalt and nickel layer is formed on the surface of a copper foil that was subject to copper roughening treatment, and a rustproof layer is additionally formed thereon as needed, has superior alkali etching properties, and maintains favorable characteristics of hydrochloric acid resistance, heat resistance and weather resistance; and this copper foil allows for achieving the surface of a red color. And, this is particularly suitable for use in a flexible substrate capable of forming a fine pattern circuit.

1. A surface-treated copper foil, wherein a plated layer essentially consisting of cobalt and nickel, in which a total amount of cobalt and nickel is 75 μg/dm² or more and 200 μg/dm² or less and Co/Ni is 1 or more and 3 or less, is provided on the roughened surface of a copper foil.

2. The surface-treated copper foil according to claim 1, wherein a rustproof layer consisting of a mixed film of chromium oxide and zinc and/or zinc oxide is provided on the plated layer essentially consisting of cobalt and nickel.

3. The surface-treated copper foil according to claim 2, wherein a silane coupling agent is provided on the rustproof layer.

4. The surface-treated copper foil according to claim 3, wherein, according to a color difference ΔE* based on JIS Z 8730, when a color difference after performing the copper roughening treatment is expressed in ΔE*(A), a color difference after performing electroplating treatment for yielding a rustproof effect in addition to performing the copper roughening treatment is expressed in ΔE*(B), and ΔE*(A)−ΔE*(B) is expressed in ΔE*(C), ΔE*(C) is 3 or more and 9 or less.

5. The surface-treated copper foil according to claim 2, wherein, according to a color difference ΔE* based on JIS Z 8730, when a color difference after performing the copper roughening treatment is expressed in ΔE*(A), a color difference after performing electroplating treatment for yielding a rustproof effect in addition to performing the copper roughening treatment is expressed in ΔE*(B), and ΔE*(A)−ΔE*(B) is expressed in ΔE*(C), ΔE*(C) of the surface-treated copper foil is 3 or more and 9 or less.

6. The surface-treated copper foil according to claim 1, wherein, according to a color difference ΔE* based on JIS Z 8730, when a color difference after performing the copper roughening treatment is expressed in ΔE*(A), a color difference after performing electroplating treatment for yielding a rustproof effect in addition to performing the copper roughening treatment is expressed in ΔE*(B), and ΔE*(A)−ΔE*(B) is expressed in ΔE*(C), ΔE*(C) of the surface-treated copper foil is 3 or more and 9 or less.
